(19) United States
(12) Patent Application Publication
(10) Pub. No.: US 2022/0181940 A1
(43) Pub. Date: Jun. 9, 2022

(54) REDUNDANT RESOLVER

(71) Applicant: Joby Aero, Inc., Santa Cruz, CA (US)

(72) Inventors: Jonathan Wagner, Santa Cruz, CA (US); Martin van der Geest, Santa Cruz, CA (US); Jessica Colton, Santa Cruz, CA (US); Bradley Landseadel, Santa Cruz, CA (US)

(21) Appl. No.: 17/542,034

(22) Filed: Dec. 3, 2021

Related U.S. Application Data
(60) Provisional application No. 63/129,420, filed on Dec. 22, 2020.
(60) Provisional application No. 63/121,124, filed on Dec. 3, 2020.

(51) Int. Cl. H02K 3/28; H02K 24/00; H02K 3/52

(52) U.S. Cl. CPC H02K 3/28; H02K 3/521; H02K 24/00

(57) ABSTRACT

A device for rotary or linear position sensing includes a stator with a plurality of teeth, an excitation winding wrapped around at least some of the plurality of teeth, and multiple sense windings for detecting changes in voltage output. The windings are in two sets in which each set can independently determine the change in voltage output. A control circuit generates a first output signal representing a relative position of the stator based on excitation of the first sense winding set by the excitation winding and a second output signal representing a relative position of the stator based on excitation of the second sense winding set by the excitation winding.

### CROSS-REFERENCE TO RELATED APPLICATIONS

This patent application claims the benefit of U.S. Provisional Patent Application Ser. No. 63/121,124 filed on Dec. 3, 2020 and U.S. Provisional Patent Application Ser. No. 63/129,420 filed on Dec. 22, 2020, both of which are hereby incorporated by reference herein in their entireties.

### BACKGROUND

This disclosure relates generally to the field of position sensing and more specifically to position sensing devices known as resolvers.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. To easily identify the discussion of any particular element or act, the most significant digit or digits in a reference number refer to the figure number in which that element is first introduced.

FIG. 1 illustrates a schematic representation of a first variant of a redundant resolver according to some examples.

FIG. 2 illustrates a schematic representation of a second variant of a redundant resolver according to some examples.

FIG. 3 illustrates a system including a redundant resolver in conjunction with a motor according to some examples.

FIG. 4 shows a cross section of a winding configuration for a resolver using a dual winding configuration according to some examples.

FIG. 5 shows an example of a cross section of a second winding configuration according to some examples.

FIG. 6 shows a cross section of a third winding configuration according to some examples.

FIG. 7 shows a of a cross section of a fourth winding configuration 700 according to some examples.

FIG. 8 shows a cross section of a fifth winding configuration 800 according to some examples.

FIG. 9 shows a schematic representation of possible wire gauge thickness for the windings according to some examples.

FIG. 10 shows a cross section of a sixth winding configuration according to some examples.

FIG. 11 shows a system including a control infrastructure, a redundant resolver and a motor according to some examples.

FIG. 12 shows a resolver including a split stator with independent control infrastructures according to some examples.

### DETAILED DESCRIPTION

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Disclosed is a redundant resolver that includes components for one or more resolvers in a common housing, in some examples. The redundant resolver functions to provide redundancy (e.g., electrical redundancy, operational redundancy) in a single package. For example, the redundant resolver can be used in aircraft applications (e.g., to measure motor rotation, propeller rotation, tilt mechanism rotation, and/or rotation of any other suitable component).

The redundant resolver may include one or more instances of one or more components from one or more resolvers (e.g., standard resolvers). In some examples the resolver includes the components of two or more resolvers (e.g., forms a dual resolver), but can alternatively include multiple instances of a resolver component (e.g., the sense and or excitations windings), components from any other suitable number of resolvers, and/or other components.

In some examples provided is a device for position sensing comprising a stator including a plurality of teeth, an excitation winding wrapped around at least some of the plurality of teeth, a first sense winding set wrapped around at least some of the plurality of teeth, a second sense winding set wrapped around at least some of the plurality of teeth, and control circuitry to generate a first output signal representing a relative position of the stator based on excitation of the first sense winding set by the excitation winding and a second output signal representing a relative position of the stator based on excitation of the second sense winding set by the excitation winding.

The excitation winding may comprise a first excitation wire and a second excitation wire, the first sense winding set may comprise a first sense wire and a second sense wire, and the second sense winding set comprises a third sense wire and a fourth sense wire. The first sense winding set may be wrapped around the first excitation wire, the second excitation wire may be wrapped around the first sense winding set, and the second sense winding set may be wrapped around the second excitation wire.

The first sense winding set may also be wrapped around a first set of teeth in the plurality of teeth, and the second sense winding set is wrapped around a second set of teeth in the plurality of teeth.

In some examples, the excitation winding is wrapped around at least some of the teeth of the plurality of teeth, the first sense winding set is wrapped over the excitation winding, and the second sense winding set is wrapped over the first sense winding set. The first sense winding set and the second sense winding set may also be interspersed over the excitation winding.

The excitation winding may be wound on at least some of the teeth of the plurality of teeth, the first sense winding set may be wound around upper portions of the teeth, and the second sense winding set may be wound around lower portions of the teeth such that there is air gap between the first sense winding set and the second sense winding set.

The first sense winding set and the second sense winding set may increase in wire thickness as a circumferential distance from a tooth increases. The stator may comprise a first stator portion forming a segment of the stator and a second stator portion forming a separate segment of the stator. The excitation winding may also comprise a single excitation wire for exciting both the first and the second sense winding sets.

In some examples, the control circuitry comprises a first control circuit to generate the first output signal representing a relative position of the stator based on excitation of the first sense winding set by the excitation winding, and a second control circuit to generate the second output signal representing a relative position of the stator based on excitation of the second sense winding set by the excitation winding. The control circuitry may also comprise a first control circuit to excite the first excitation wire and generate the first output signal representing a relative position of the stator based on excitation of the first sense winding set by the first excitation wire, and a second control circuit to excite the second excitation wire and to generate the second output signal representing a relative position of the stator based on excitation of the second sense winding set by the second excitation wire.

In some examples, provided is a device for rotary position sensing comprising a rotor, a stator coupled to the rotor for relative movement between the rotor and the stator, the stator including a plurality of teeth, a first excitation winding wrapped around at least some of the plurality of teeth, a first sense winding set wrapped around at least some of the plurality of teeth, the first sense winding set including a plurality of sense coil, a second sense winding set wrapped around at least some of the plurality of teeth, the second sense winding set including a plurality of sense coils, and a second excitation winding wrapped around at least some of the plurality of teeth.

In some examples, the first sense winding set is wrapped around the first excitation winding, the second excitation winding is wrapped around the first sense winding set, and the second sense winding set is wrapped around the second excitation winding Alternatively, the first sense winding set may be wrapped around a first set of teeth in the plurality of teeth, and the second sense winding set may be wrapped around a second set of teeth in the plurality of teeth.

Further the excitation winding maybe wrapped around at least some of the teeth of the plurality of teeth, the first sense winding set may comprise a first sense coil and a second sense coil and the second sense winding set may comprise a third sense coil and a fourth sense coil, wherein the third sense coil is wrapped over the first sense coil, the second sense coil is wrapped over the third sense coil, and the fourth sense coil is wrapped over the second sense wire. The first sense winding set may also be wound around upper portions of the teeth while the second sense winding set is wound around lower portions of the teeth.

The stator may comprise a first stator portion forming a segment of the stator and a second stator portion forming a separate segment of the stator, and the first sense winding set may be wound around teeth in the first stator portion and the second winding set may be wound around teeth in the second stator portion.

The device for rotary position sensing may also further comprise a first control circuit to generate a first output signal representing a relative position of the stator based on excitation of the first sense winding set by the first excitation winding, and a second control circuit to generate a second output signal representing a relative position of the stator and the rotor based on excitation of the second sense winding set by the second excitation winding.

The device for rotary position sensing may also further comprise a first control circuit to excite the first excitation winding and to generate a first output signal representing a relative position of the stator and the rotor based on excitation of the first sense winding set by the first excitation winding, and a second control circuit to excite the second excitation winding and to generate a second output signal representing a relative position of the stator and the rotor based on excitation of the second sense winding set by the second excitation winding.

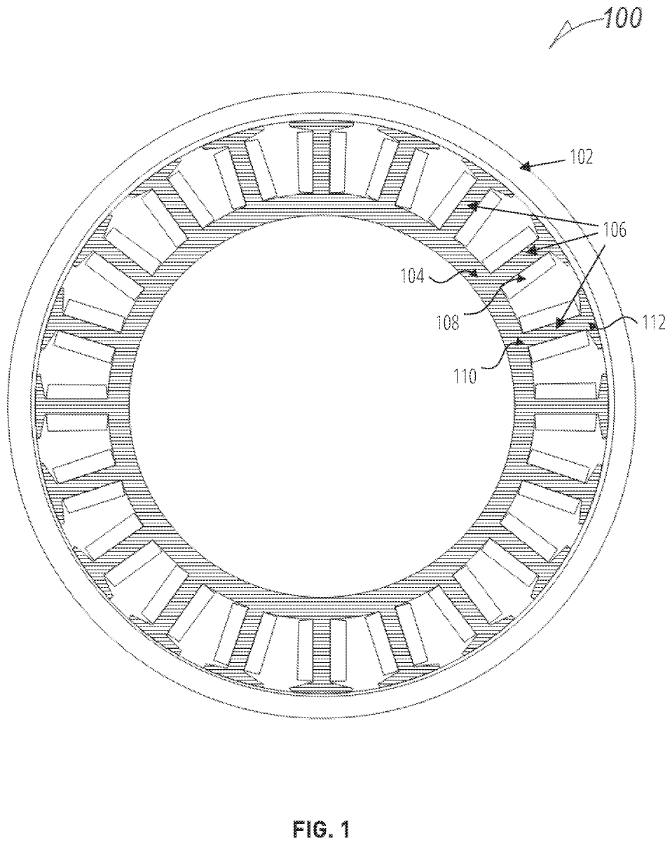

FIG. 1 illustrates a schematic representation of a first variant of a redundant resolver according to some examples. The resolver 100 includes a rotor 102 and a stator 104. As shown in FIG. 1, the rotor 102 is located around the stator 104, but the stator 104 could equally be located around the rotor 102. The stator 104 includes a plurality of teeth 106 and a plurality of windings 108 around at least some of the teeth 106. The windings 108 around the teeth 106 include excitation windings and sense windings as will be discussed in more detail below. The resolver 100 in use functions to provide a varying electric signal based on the relative angular position of the stator 104 and the rotor 102, from which rotational position information of related components can be inferred or determined.

The resolver 100 is a variable reluctance resolver, however the technology can additionally or alternatively be applied to a brushless resolver, brushed resolver, linear resolver, linear variable differential transformer (LVDT), rotary variable differential transformer (RVDT), synchro, receiver resolver, differential resolver, or any other suitable device.

Additionally, while the concepts and structures are described herein primarily with reference to the sensing of relative rotational positions between a stator and a rotor, it will be appreciated that the concepts and structures are equally applicable to the detection of relative linear positions in some examples, in which linear structures corresponding to the stator and rotor are provided.

The rotor 102 is coupled in use to a rotating body (e.g., a shaft or rotor of a motor) and relative angular motion between the rotor 102 and the stator 104 creates a variable reluctance between the teeth 106 of the stator 104 and the rotor 102. A magnetic field can be generated by the excitation windings around the teeth 106 and the variation in the reluctance between the teeth 106 of the stator and the rotor 102 can be detected by the sense windings around the teeth 106 as will be discussed in more detail below.

The rotor 102 can for example include a set of lobes distributed about the rotor such that the distance between the teeth 106 of the stator 104 and the rotor 102 varies based on the relative angular position between the rotor 102 and the stator 104. Other configurations are possible and known in the art. The illustrated rotor is formed from a ferrous metal (e.g., iron, grain-oriented silicon steel, etc.), but can be constructed of any suitable material(s). Where both the rotor 102 and stator 104 are cylindrical, the rotor axis can be parallel to but offset from the stator axis (e.g., non-concentric), effectively forming a rotor with a single lobe. However, the rotor can exclude lobes altogether, excitation windings may be located on the rotor, (as employed with a rotor-excited resolver), and/or can be otherwise suitably configured.

The stator 104 includes electrical connections that function to electrically connect the plurality of windings 108 to control infrastructure. The teeth 106 can be configured with any suitable angular resolution, numerosity, radial length, axial width, thickness, angular spacing, air gap dimension (e.g., minimum air gap width, maximum air gap width, etc.), and/or any other suitable parameters. Each of the teeth 106 extends from a base 110 of the tooth up to a circumferential flange 112 that partially serves to retain the windings 108 in addition to providing magnetic coupling with the rotor 102. The thickness of the tooth between the base 110 and the circumferential flange 112 is uniform but can be variable and/or otherwise suitable configured. The radial length of the tooth is defined as the minimum distance between the base 110 and the circumferential flange 112 but can be otherwise suitably defined.

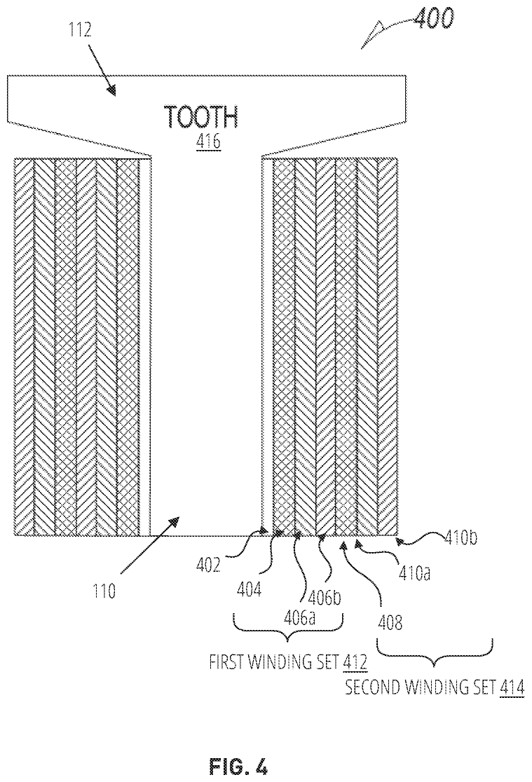

A traditional resolver includes an excitation winding and a pair of sense windings. To provide redundancy, the windings 108 in FIG. 1 include at least a second set of sense windings and optionally a second excitation winding. Various alternative implementations are discussed below with reference to FIGS. 4 to 10. In the example shown in FIG. 1, the second set of sense windings and the (optional) second excitation winding are provided together with the first set of sense windings and the first excitation winding around the stator 104. Alternatively, the first set of sense windings and the first excitation winding may be provided in one half or one segment of the stator 104 while the second set of windings may be provided in the other half or another segment of the stator 104. Furthermore, the first set of sense windings and the first excitation winding may be provided on certain teeth of the stator 104 while the second set of windings may be provided on other teeth of the stator 104, for example on alternating teeth.

In the event of the failure in one of the sets of sense windings, the other set of sense windings can provide angular output signals in its place. Similarly, in the case of first and second excitation windings, in the event of a failure in one excitation winding, the other excitation winding and its set of sense windings can provide angular out signals in its place.

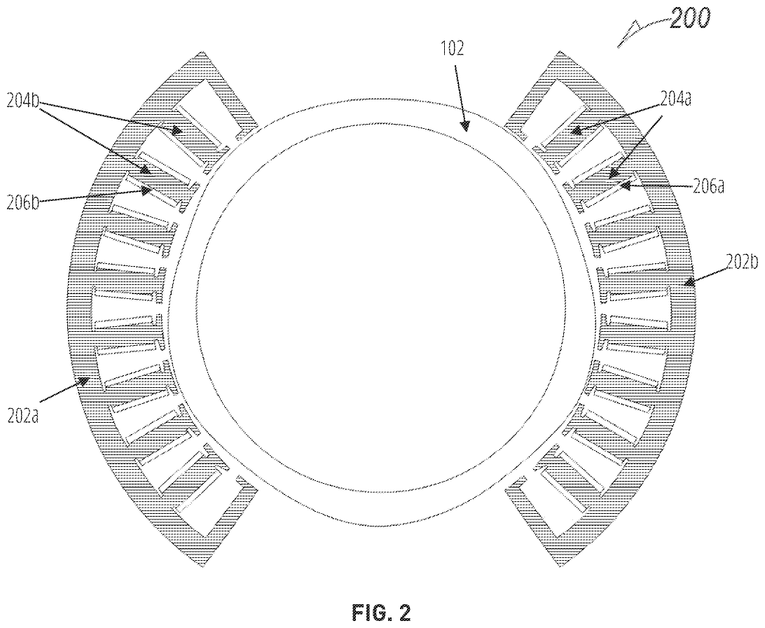

FIG. 2 illustrates a schematic representation of a second variant of the redundant resolver 200 according to some examples. The resolver 200 includes a rotor 102, a first stator portion 202a and a second stator portion 202b. The first stator portion 202a includes teeth 204a and windings 206a while the second stator portion 202b includes teeth 204b and windings 206b. In this example, the stator portions 202a and 202b are located around the outside of the rotor 102 on opposite sides. Windings 206a and 206b are coiled around the teeth 106 forming field coils around each tooth. In this example, the stator portions 202a and 202b are located around the outside of the rotor 102 within a housing such that the stator portion 202a and the second stator portion 202b are on opposite sides of the rotor.

The teeth 204a and 204b can be unevenly distributed between the first stator of the stator portion 202a and the second stator of the stator portion 202b. The teeth 204a and 204b can be configured with any suitable angular resolution, number of teeth, radial length, axial width, thickness, angular spacing, air gap dimension (e.g., minimum air gap width, maximum air gap width, etc.), and/or any other suitable parameters. As before, each of the teeth 204a and 204b extend from a base 110 of the tooth up to a circumferential flange 112 that partially serves to retain the windings 206a and 206b in addition to providing magnetic coupling with the rotor 102. The thickness of the tooth between the base 110 and the circumferential flange 112 is uniform but can be variable and/or otherwise suitable configured. The radial length of the tooth is defined as the minimum distance between the base 110 and the circumferential flange 112 but can be otherwise suitably defined. However, the teeth 106 can have any other suitable geometry or features.

In the example of FIG. 2, a first set of sense windings and a first excitation winding may be provided in the first stator portion 202a while a second set of sense windings and a second excitation winding may be provided in the second stator portion 202b, to provide redundancy. Alternatively, the first and second set of sense windings are provided together throughout the first and second stator portions, with a second excitation winding optionally provided in addition to the first excitation winding.

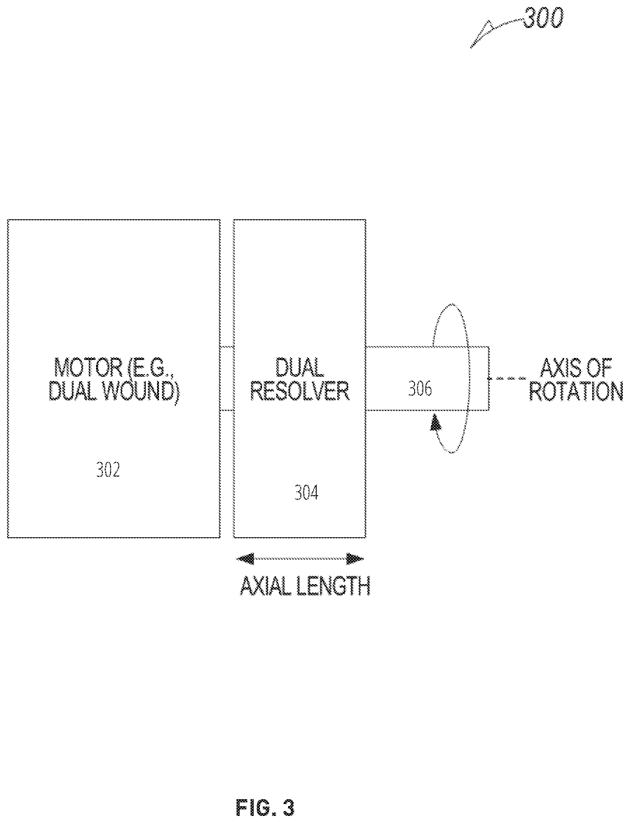

FIG. 3, illustrates a system 300 including a redundant resolver 304 in conjunction with a motor 302 according to some examples. The resolver 304 is mounted to an output shaft 306 of the motor 302 via its rotor, and its stator is coupled or mounted to the motor 302 or to another fixed surface or object such that rotation of the output shaft 306 causes corresponding rotation of the redundant resolver's rotor relative to its stator. The redundant resolver 304 has a fixed, relatively short axial length to permit flexible and convenient mounting of the redundant resolver 304 in conjunction with the motor 302. The motor 302 may be a dual-wound actuator such as a motor, servo, or other dual-wound electro-mechanical actuator.

The redundant resolver 304 may for example be a resolver as shown in and described with reference to FIG. 1 or FIG. 2.

FIG. 4 shows a cross section of a winding configuration 400 for a resolver according to some examples. The winding configuration includes a first winding set 412 wrapped around a tooth 416 with a second winding set 414 wrapped around the first winding set 412. Here the tooth 416 is wrapped in insulation 402 that functions to electrically insulate the first winding set 412 from the tooth. The insulation 402 can be formed with Nomex® (from DuPont™), plastic encapsulation, Kapton® tape (from DuPont™), slot liners, over molded, additively manufactured plastic, and/or otherwise suitably fabricated.

The winding set 412 is formed by a sense winding 406a and a sense winding 406b that are wrapped around a first excitation winding 404. The second winding set is formed by a sense winding 410a and a sense winding 410b that are wrapped around an excitation winding 408.

As shown in FIG. 4, the first and second winding sets can be coiled around a full radial length of each tooth 416 (e.g., between the base 110 and the flange 112), but may otherwise be suitably coiled around a tooth 416. The combined thickness of the first and second sets of windings in a circumferential direction about the stator can be the same for each set of windings, different for each set of windings, vary according to a coil radius (e.g., distance from coil to the tooth; based on coil impedance), and/or any other suitable coil thickness. Likewise, the number of turns per coil and/or the wire gauge of each winding can be the same and/or different for each winding (e.g., according to coil thickness, coil impedance, etc.).

The excitation windings 404 and 408 may be energized in phase, out-of-phase at the same voltage, or with different voltages, or only as needed (for example if the active winding set fails, the other winding set may be activated). The redundant excitation windings 404 and 408 are connected to the control infrastructure at distinct end terminations and, accordingly, can be separately or independently energized.

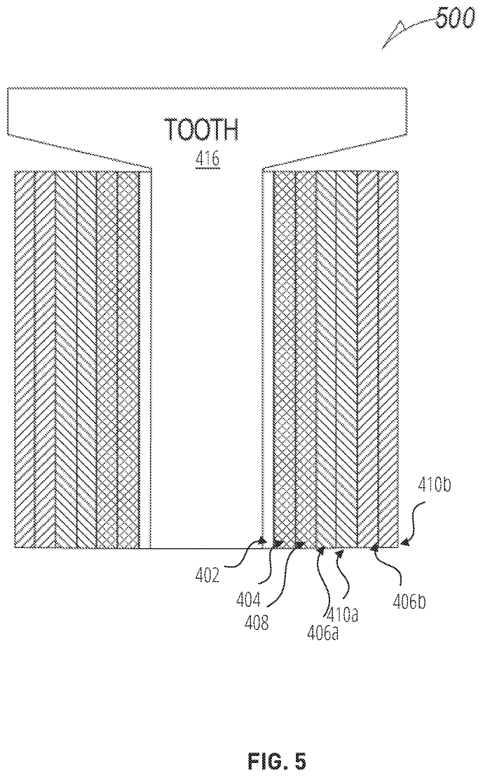

FIG. 5 shows a cross section of a second winding configuration 500 according to some examples. This winding configuration intersperses the windings of the first winding set with the windings of the second winding set. Here excitation winding 404 from the first winding set is wrapped around the tooth and excitation winding 408 from the second winding set is wrapped around excitation winding 404. The sense windings are then wrapped around the excitation windings in the following order: sense winding 406a from the first winding set followed by sense winding 410a from the second winding set followed by sense winding 406b from the first winding set and sense winding 410b from the second winding set.

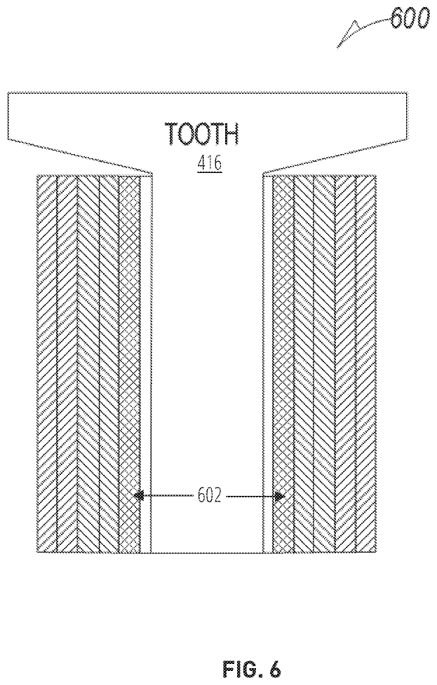

FIG. 6 shows a cross section of a third winding configuration 600 according to some examples. The winding configuration 600 includes a single excitation winding 602 that is used in a dual sense configuration to provide excitation to the sense windings in both a first and a second set of sense windings. The first and second sets of sense windings can be sequential as shown in FIG. 4 or interleaved as shown in FIG. 5. The example of FIG. 6 thus provides redundancy in the event of failure of one of the sets of sense windings but not in the case of failure of the single excitation winding 602.

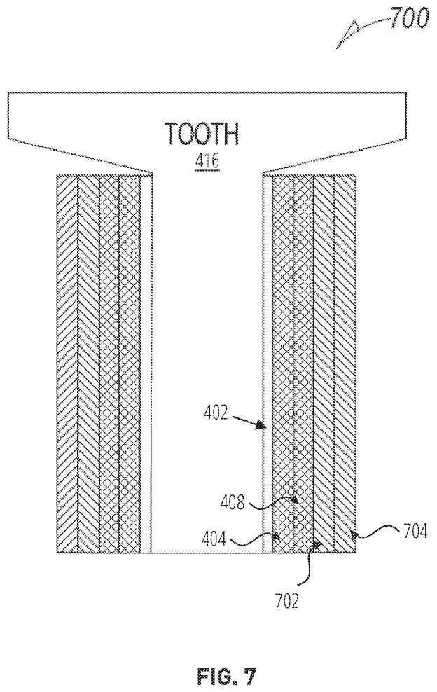

FIG. 7 shows a cross section of a fourth winding configuration 700 according to some examples. The configuration 700 provides a dual excitation configuration with a single sense winding set. Here the insulation 402 around the tooth 416 is followed by first excitation winding 404 and second excitation winding 408 followed by a single set of sense windings 702 and 704. The example of FIG. 7 thus provides redundancy in the event of failure of one of the excitation windings but not in the case of failure in the single set of sense windings.

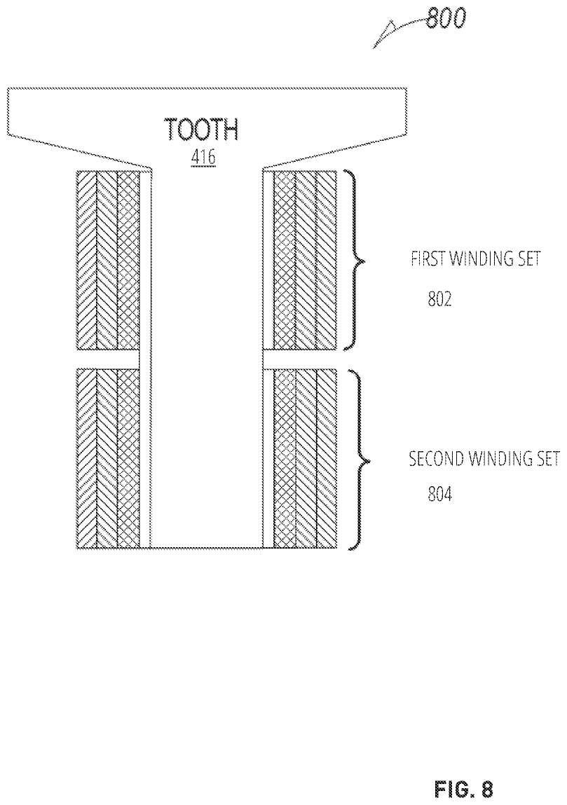

FIG. 8 shows a cross section of a fifth winding configuration 800 according to some examples. The winding configuration 800 includes a first winding set 802 and a second winding set 804 that are separate from each other and offset along a radial direction of a tooth 416. As before, first winding set 802 includes an excitation winding and first and second sense windings, and second winding set 804 includes an excitation winding and first and second sense windings. By separating the first winding set 802 and second winding set 804 in this manner, the chances of the two winding sets mechanically or magnetically interfering with each other is reduced. In some examples, an air gap may be provided between first winding set 802 and second winding set 804. In some examples the first winding set 802 is wound around the upper portion of a tooth 106 adjacent to the flange 112 and the second winding set 804 is wound around the lower portion of the tooth adjacent to its base 110.

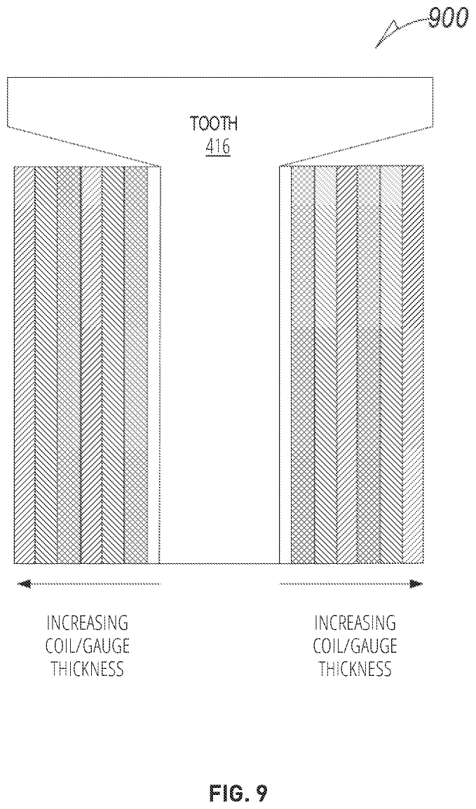

FIG. 9 shows a schematic representation of possible wire gauge thickness for the windings 108 according to some examples. This includes both excitation windings and sense windings as shown in the previous winding configurations. The wire gauge of the windings can be less than 32 AWG, 32 AWG, 33 AWG, 34 AWG, 35 AWG, 36 AWG, 37 AWG, 38 AWG, greater than 38 AWG, or any range bounded by the aforementioned values, and/or any other suitable gauge. FIG. 9 also shows that the wire gauges of the windings can also increase as the windings are wrapped over each other and are circumferentially further away from the tooth.

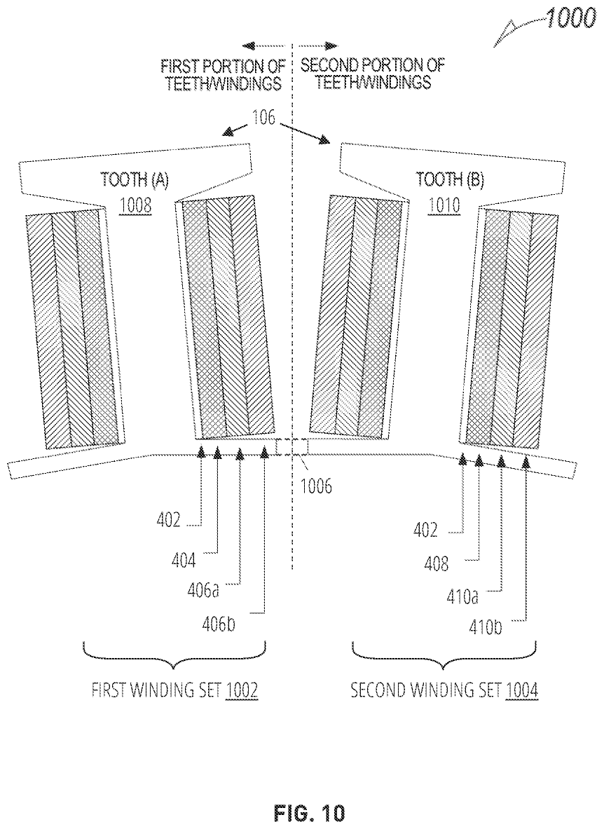

FIG. 10 shows a cross section of a sixth winding configuration 1000 according to some examples. Instead of having the dual winding configuration together on all the teeth 106 of the stator 104, the first winding set 1002 is wound around a first subset of the teeth 106 of the stator 104 and second winding set 1004 is wrapped around another subset of the teeth 106 of the stator 104. The number of teeth 106 in each subset of teeth can be equal or one subset can include a larger number of teeth 106 than the other. The first subset of teeth 1008 can be connected by a connector 1006 to the second subset of teeth 1010. The connector 1006 can connect one or more of the first subset of teeth 1008 to one or more of the second subset of teeth 1010. In a split stator configuration as shown in FIG. 2, first winding set 1002 can be around the teeth in the first stator portion 202a and the second winding set can be around the teeth in the second stator portion 202b.

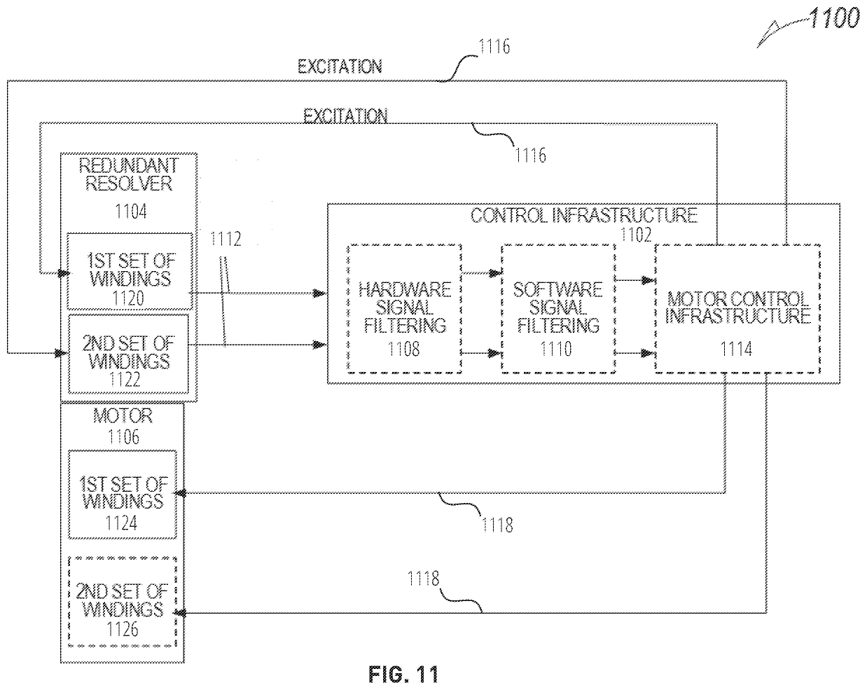

FIG. 11 shows an example of a system 1100 including a control infrastructure 1102, a redundant resolver 1104, and a motor 1106 according to some examples. The control infrastructure 1102 includes a hardware signal filtering module 1108 and/or a software signal filtering module 1110 that receive and process output signals 1112 from the redundant resolver. The filtering modules 1108 and/or 1110 include any suitable filtering, which can disambiguate the influences of DC resistance, self-inductance, and/or mutual couplings on the sense windings. In variants in which the redundant sets of windings are magnetically decoupled, the control infrastructure 1102 can comprise conventional resolver control hardware, duplicated as needed. The control infrastructure 1102 also includes a motor control infrastructure 1114 that provides excitation signals 1116 to the redundant resolver 1104 and excitation signals 1118 to the motor 1106. The control infrastructure 1102 may be implemented as analog or digital circuitry with any appropriate logic to provide the excitation, sensing and control described herein.

The redundant resolver 1104 includes a first set of windings 1120 and a second set of windings 1122 that are arranged in one of the configurations described above with reference to FIGS. 1 to 10. The redundant resolver 1104 also includes one or more electrical termination that electrically connect the first set of windings 1120 and the second set of windings 1122 to the control infrastructure 1114 to receive the excitation signals 1116 from the control infrastructure 1114, and to provide output signals 1112 to the control infrastructure 1114 respectively.

The motor 1106 includes one or more sets of windings 1124, 1126 that receive excitation signals 1118 from the control infrastructure 1114. In use, the motor 1106 is driven by the excitation signals 1118 to turn a shaft of the motor, which turns a rotor of the redundant resolver 1104 relative to a stator of the redundant resolver 1104. One or more excitation windings in the redundant resolver 1104 are excited by the excitation signals 1116. Variation in the relative angular position of the rotor and the stator provides the output signals 1112 from one or more sets of sense windings on the stator.

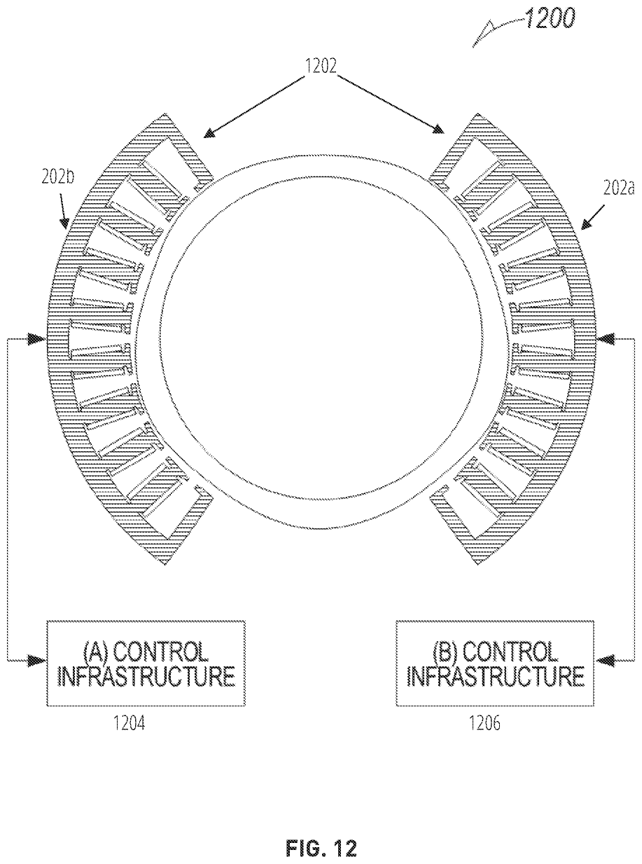

FIG. 12 shows a resolver 1200 including a split stator 1202 with independent control infrastructures 1204 and 1206 according to some examples. As in FIG. 2, the resolver 1200 includes a first stator portion 202a having a control infrastructure 1204 and a second stator portion 202b having a control infrastructure 1206. By having independent control infrastructures, redundancy is provided for this aspect of the resolver 1200 as well. The control infrastructures 1204 and 1206 are substantially similar to the control infrastructure 1114 with the exception that motor control is likely to be provided by a separate motor control infrastructure. Note that the use of independent control structures for the first and second sets of windings is not dependent on having a split stator, and the control infrastructure(s) of FIG. 12 could be used in the system of FIG. 11 and vice versa. The control infrastructures 1204 and 1026 may be implemented as analog or digital circuitry with any appropriate logic to provide the excitation, sensing and control described herein.

Terms used herein should be accorded their ordinary meaning in the relevant arts, or the meaning indicated by their use in context, but if an express definition is provided, that meaning controls.

“Circuitry” and “Circuits” include electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment). Circuitry and circuits can be analog or digital or some combination thereof.

“Firmware” includes software logic embodied as processor-executable instructions stored in read-only memories or media.

“Hardware” includes logic embodied as analog or digital circuitry.

“Logic” includes machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware or software embodied thereon are examples of logic. Logic specifically excludes pure signals or software per se, however it does not exclude machine memories comprising software and thereby forming configurations of matter.

“Software” includes logic implemented as processor-executable instructions in a machine memory (e.g. read/write volatile or nonvolatile memory or media).

What is claimed is:

1. A device for position sensing comprising:
a stator including a plurality of teeth;
an excitation winding wrapped around at least some of the plurality of teeth;
a first sense winding set wrapped around at least some of the plurality of teeth;
a second sense winding set wrapped around at least some of the plurality of teeth; and
control circuitry to generate a first output signal representing a relative position of the stator based on excitation of the first sense winding set by the excitation winding and a second output signal representing a relative position of the stator based on excitation of the second sense winding set by the excitation winding.

2. The device as in claim 1, wherein:
the excitation winding comprises a first excitation wire and a second excitation wire;
the first sense winding set comprises a first sense wire and a second sense wire; and
the second sense winding set comprises a third sense wire and a fourth sense wire.

3. The device of claim 2, wherein:
the first sense winding set is wrapped around the first excitation wire;
the second excitation wire is wrapped around the first sense winding set; and
the second sense winding set is wrapped around the second excitation wire.

4. The device of claim 2, wherein:
the first sense winding set is wrapped around a first set of teeth in the plurality of teeth; and
the second sense winding set is wrapped around a second set of teeth in the plurality of teeth.

5. The device of claim 1, wherein the excitation winding is wrapped around at least some of the teeth of the plurality of teeth,
the first sense winding set is wrapped over the excitation winding, and
the second sense winding set is wrapped over the first sense winding set.

6. The device of claim 1, wherein the excitation winding is wrapped around at least some of the teeth of the plurality of teeth, and
the first sense winding set and the second sense winding set are interspersed over the excitation winding.

7. The device of claim 1, wherein:
the excitation winding is wound on at least some of the teeth of the plurality of teeth;
the first sense winding set is wound around upper portions of the teeth, and
the second sense winding set is wound around lower portions of the teeth such that there is air gap between the first sense winding set and the second sense winding set.

8. The device of claim 1, wherein the first sense winding set and the second sense winding set increase in wire thickness as a circumferential distance from a tooth increases.

9. The device of claim 1, wherein the stator comprises a first stator portion forming a segment of the stator and a second stator portion forming a separate segment of the stator.

10. The device of claim 1 wherein the excitation winding comprises a single excitation wire for exciting both the first and the second sense winding sets.

11. The device of claim 1, wherein
the control circuitry comprises a first control circuit to generate the first output signal representing a relative position of the stator based on excitation of the first sense winding set by the excitation winding, and a second control circuit to generate the second output signal representing a relative position of the stator based on excitation of the second sense winding set by the excitation winding.

12. The device of claim 2 wherein the control circuitry comprises:
a first control circuit to excite the first excitation wire and generate the first output signal representing a relative position of the stator based on excitation of the first sense winding set by the first excitation wire; and
a second control circuit to excite the second excitation wire and to generate the second output signal representing a relative position of the stator based on excitation of the second sense winding set by the second excitation wire.

13. A device for rotary position sensing comprising:
rotor;
a stator coupled to the rotor for relative movement between the rotor and the stator, the stator including a plurality of teeth;
a first excitation winding wrapped around at least some of the plurality of teeth;
a first sense winding set wrapped around at least some of the plurality of teeth, the first sense winding set including a plurality of sense coils;
a second sense winding set wrapped around at least some of the plurality of teeth, the second sense winding set including a plurality of sense coils; and
a second excitation winding wrapped around at least some of the plurality of teeth.

14. The device of claim 13, wherein:
the first sense winding set is wrapped around the first excitation winding;
the second excitation winding is wrapped around the first sense winding set; and
the second sense winding set is wrapped around the second excitation winding.

15. The device of claim 13, wherein:
the first sense winding set is wrapped around a first set of teeth in the plurality of teeth; and
the second sense winding set is wrapped around a second set of teeth in the plurality of teeth.

16. The device of claim 13, wherein the excitation winding is wrapped around at least some of the teeth of the plurality of teeth, wherein the first sense winding set comprises a first sense wire and a second sense wire and the second sense winding set comprises a third sense wire and a fourth sense wire, wherein the third sense wire is wrapped over the first sense wire, the second sense wire is wrapped over the third sense wire, and the fourth sense wire is wrapped over the second sense wire.

17. The device of claim 13, wherein:
the first sense winding set is wound around upper portions of the teeth, and
the second sense winding set is wound around lower portions of the teeth.

18. The device of claim 13, wherein the stator comprises a first stator portion forming a segment of the stator and a second stator portion forming a separate segment of the stator and the first sense winding set is wound around teeth in the first stator portion and the second winding set is wound around teeth in the second stator portion.

19. The device of claim 13, further comprising:
a first control circuit to generate a first output signal representing a relative position of the stator based on excitation of the first sense winding set by the first excitation winding; and
a second control circuit to generate a second output signal representing a relative position of the stator and the rotor based on excitation of the second sense winding set by the second excitation winding.

20. The device of claim 13, further comprising:
a first control circuit to excite the first excitation winding and to generate a first output signal representing a relative position of the stator and the rotor based on excitation of the first sense winding set by the first excitation winding; and
a second control circuit to excite the second excitation winding and to generate a second output signal representing a relative position of the stator and the rotor based on excitation of the second sense winding set by the second excitation winding.
